(19) United States
(12) Patent Application Publication
(10) Pub. No.: US 2006/0252869 A1
(43) Pub. Date: Nov. 9, 2006

(54) Synergistic filler compositions and low density sheet molding compounds therefrom

(75) Inventors: Helena Twardowska-Baxter, Dublin, OH (US); Michael J. Sumner, Dublin, OH (US); Dennis H. Fisher, Westerville, OH (US)

Correspondence Address: CONNOLLY BOVE LODGE & HUTZ LLP, P.O. BOX 2207, WILMINGTON, DE, 19899-2207, US

(73) Assignee: Ashland Inc., Ashland, KY (US)

(21) Appl. No.: 11/124,356

(22) Filed: May 9, 2005

(51) Int. Cl. C08K 9/04

(52) U.S. Cl. 524/445

(57) ABSTRACT

The present disclosure relates generally to resin formulations for sheet molding compounds. Particularly, but not by way of limitation, the disclosure relates to low-density thermosetting sheet molding compounds (SMC) comprising a treated inorganic clay, a thermosetting resin, a low profile agent, a reinforcing agent, a low-density filler, and substantially the absence of calcium carbonate. The thermosetting SMC are used to prepare exterior and structural thermoset articles, e.g. auto parts and panels, etc that have Class A Surface Quality.

### FIELD OF THE INVENTION

The present invention relates generally to resin formulations for sheet molding compounds. Particularly, but not by way of limitation, the invention relates to low-density thermosetting sheet molding compounds (SMC) comprising an organic-modified, inorganic clay, a thermosetting resin, a low profile agent, a reinforcing agent, a low-density filler, and substantially the absence of calcium carbonate. The thermosetting SMC is used to prepare exterior and structural thermoset articles, e.g. automotive parts, panels, etc having Class A Surface Quality.

### BACKGROUND

The information provided below is not admitted to be prior art to the present invention, but is provided solely to assist the understanding of the reader.

The transportation industry makes extensive use of standard composite parts formed from sheet molding compound (SMC). Sheet molding compound comprising unsaturated polyester fiberglass reinforced plastics (FRP) are extensively used in exterior body panel applications due to their corrosion resistance, strength, and resistance to damage. The automotive industry has very stringent requirements for the surface appearance of these body panels. This desirable smooth surface is generally referred to as a “class A” surface. Surface quality (SQ), as measured by the Laser Optical Reflected Image Analyzer (LORIA), is determined by three measurements—Ashland Index (AI), Distinctness of Image (DOI), and Orange Peel (OP). SMC with Class A SQ is typically defined as having an AI<80, a DOI≧70 (scale 0-100), and an OP≧7.0 (scale 0-10).

A molded composite article is a shaped, solid material that results when two or more different materials having their own unique characteristics are combined to create a new material, and the combined properties, for the intended use, are superior to those of the separate starting materials. Typically, the molded composite article is formed by curing a shaped sheet molding compound (SMC), which comprises a fibrous material, e.g. glass fibers, embedded into a polymer matrix. While the mechanical properties of a bundle of fibers are low, the strength of the individual fibers is reinforced by the polymer matrix that acts as an adhesive and binds the fibers together. The bound fibers provide rigidity and impart structural strength to the molded composite article, while the polymeric matrix prevents the fibers from separating when the molded composite article is subjected to environmental stress.

The polymeric matrix of the molded composite article is formed from a thermosetting resin, which is mixed with fibers used to make a SMC. Thermosetting polymers “set” irreversibly by a curing reaction, and do not soften or melt when heated because they chemically cross-link when they are cured. Examples of thermosetting resins include phenolic resins, unsaturated polyester resins, vinyl ester resins, polyurethane-forming resins, and epoxy resins.

Although molded composite article made from SMC based on thermosetting polymers typically have good mechanical properties and surface finish, this is achieved by loading the SMC with high levels of filler. These fillers, however, add weight to the SMC, which is undesirable, particularly when they are used to make automotive or parts of other vehicles that operate on expensive fuels. Therefore, there is an interest in developing SMC that will provide molded composite articles with good mechanical properties that have lower density, in order to improve fuel efficiency.

Additionally, the use of high levels of filler is particularly a problem when highly reactive unsaturated polyesters are used as the thermosetting polymer for making composites. Molded composite articles made from SMC formulations, which employ high reactivity unsaturated polyester resins, often shrink during cure. The shrinkage is controlled with low profile additives (LPA's) and large amounts of fillers, e.g. calcium carbonate, and kaolin clay. Although the resulting molded composite articles have good strength and surface appearance, the density of the composite is high, typically 1.9-2.0 g/cm³. Thus, when used in applications, such as automotive body parts, the added weight lowers fuel efficiency.

U.S. Pat. No. 6,287,992 relates to a thermoset polymer composite comprising an epoxy vinyl ester resin or unsaturated polyester matrix having dispersed therein particles derived from a multi-layered inorganic material, which possesses organophilic properties. The dispersion of the multi-layered inorganic material with organophilic properties in the polymer matrix is such that an increase in the average interlayer spacing of the layered inorganic material occurs to a significant extent, resulting in the formation of a nanocomposite. Although the patent discloses polymer composites, it does not disclose molded composite articles and their mechanical properties, e.g. tensile strength (psi), modulus (ksi), elongation (%), and heat distortion temperature (° C.), nor does it disclose the manufacture of SMC that contains a reinforcing agent, a LPA, and a filler. The problem with using the SMC of the '992 patent is that molded articles prepared with the SMC experience significant shrinkage and are subject to significant internal stress, resulting in the formation of cracks in molded articles.

U.S. Pat. No. 5,585,439 discloses SMC made with an unsaturated polyester resin, and teaches that the mechanical properties of the SMC can be improved if a low profile additive (LPA) is added to the SMC. However, this patent does not teach or suggest the use of nanocomposites in the SMC. The problem with the SMC disclosed in the '439 patent is that when LPA's are used alone, without large amounts of filler (e.g. calcium carbonate and kaolin clay), the molded articles prepared from them have micro and macro voids, which results in molded articles having very low strength. Thus, large amounts of conventional fillers, in addition to LPA's, are required to obtain good strength and surface appearance of molded articles.

Unsaturated polyester resins typically shrink 5-8% on a volume basis when they are cured. In an FRP, this results in a very uneven surface because the glass fibers cause peaks and valleys when the resin shrinks around them. Thermoplastic low profile additives (LPA) have been developed in order to help these materials meet the stringent surface smoothness requirements for a class A surface. LPA are typically thermoplastic polymers which compensate for curing shrinkage by creating extensive microvoids in the cured resin. Unsaturated polyester resins can now be formulated to meet or exceed the smoothness of metal parts which are also widely used in these applications.

In addition to LPA's, formulations contain large amounts of inorganic fillers such as calcium carbonate (CaCO₃). These fillers contribute in two critical ways towards the surface smoothness of these compositions. First, the fillers dilute the resin mixture. Typically, there may be twice as much filler as resin on a weight basis in a formulation. This reduces the shrinkage of the overall composition simply because there is less material undergoing shrinkage. The second function of the filler is to aid in the creation of microvoids in the LPA phase of the cured resin.

In recent years, there has been added pressure on the automotive manufacturers to reduce the weight of cars in order to improve gas mileage. While FRP's have an advantage in this respect compared to competitive materials because of lower specific gravity, the fillers mentioned previously cause the part to be heavier than necessary. Most inorganic fillers have fairly high densities. Calcium carbonate, the most commonly used filler, has a density of about 2.71 g/cc, compared to a density of about 1.2 g/cc for cured unsaturated polyester. A common FRP material used in body panel applications will have a density of about 1.9 g/cc. If this could be reduced by 10 to 20% while maintaining the other excellent properties of unsaturated polyester FRP's, a significant weight savings could be realized.

As the density is reduced, however, maintaining Class A SQ becomes difficult. The industry has expressed a need for low-density SMC having Class A SQ. The industry has expressed a need for SMC formulations that maintain mechanical properties and matrix toughness without increasing the paste viscosity above the range required for SMC sheet preparation.

Other objects and advantages will become apparent from the following disclosure.

### SUMMARY OF INVENTION

The present invention addresses the unmet needs of the prior art by providing low-density, sheet molding compounds capable of curing into structures having Class A Surface Quality.

An aspect of the present invention provides a low-density SMC comprising an SMC-paste formulation and a fibrous reinforcing roving. In a further aspect, the SMC-paste comprises filler composition containing a dispersed nanoclay, diatomaceous earth, and kaolin clay. The filler is disposed within a mix of a thermosetting resin and a reactive monomer. In a further aspect, the SMC-paste comprised additives to control various properties. An aspect provides the inventive SMC paste comprise substantially reduced levels, including the total absence, of calcium carbonate or fillers having a similar density. In a further aspect, the SMC-paste has a density of no more than about 1.25 g/cm³.

An aspect of the present invention provides a low-density SMC comprising the inventive SMC-paste and a fibrous reinforcing material, such as a fiber roving. An aspect provides the inventive SMC has a density less than about 1.6 g/cm³. A further aspect provides the inventive SMC may optionally comprise additives to maintain toughness and Class A SQ such as “rubber impact modifiers,” toughened UPE resin(s), alternative cross-linkers, and/or enhancing additives that improve the effectiveness of thermoplastic low profile additives (LPA's). A further aspect provides the inventive SMC may optionally comprise mica, wollastonite (CaSiO₃), kaolin clay, graphite, ground carbon fiber, cellulose-based fillers, and similar materials.

The present invention provides a low-density sheet molding compound formulated from thermoplastic low profile additive selected from the group consisting of saturated polyesters, polyurethanes, polymethylmethacrylates, polystyrenes, and epoxy-extended polyesters. Low profile additives are disclosed in U.S. Pat. No. 5,880,180 to Ashland, the assignee of the present invention.

The present invention provides a low-density sheet molding compound formulated from ethylenically unsaturated monomers such as, but not limited to, styrene, divinyl benzene, vinyl toluene, methacrylic esters, acrylic esters, various multi-functional acrylates and methacrylates and diallyl phthalates, and mixtures thereof.

The present invention provides a low-density sheet molding compound formulated from unsaturated polyester resins made by reacting dicarboxylic acids or their anhydrides such as maleic acid, fumaric acid, maleic anhydride, citraconic acid or anhydride, itaconic acid or anhydride, phthalic anhydride or phthalic acid, isophthalic acid, terephthalic acid, adipic acid and the like, and (b) a dihydric alcohol such as ethylene, propylene, diethylene, and/or dipropylene glycol and the like and mixtures thereof.

The present invention provides a low-density sheet-molding compound, which has a Class A SQ. According to an aspect, the inventive SMC yields a Class A surface when molded under industry-standard conditions of heat and pressure.

The invention also has inherent advantages over standard density SMC during the molding process. The increase in resin content and reduced filler level allows the sheet to flow smoothly and fill the mold at conditions of heat and pressure significantly lower than industry-standard. In addition to reducing the cost of molding parts, the reduction of mold pressure and temperature yields substantial improvement in the SQ of the part, especially the short-term DOI and OP values as shown by the data in TABLES 2 and 3.

The present invention provides an article of manufacture fabricated by heating under pressure a molding compound comprising an unsaturated polyester resin, an unsaturated monomer, a low profile additive, fillers and fiber reinforcement, wherein the article of manufacture formed has a density not greater than about 1.6 grams/cubic centimeter.

Still other aspects and advantages of the present invention will become readily apparent by those skilled in the art from the following detailed description, wherein it is shown and described preferred embodiments of the invention, simply by way of illustration of the best mode contemplated of carrying out the invention. As will be realized the invention is capable of other and different embodiments, and its several details are capable of modifications in various obvious respects, without departing from the invention. Accordingly, the description is to be regarded as illustrative in nature and not as restrictive.

### BRIEF DESCRIPTION OF DRAWINGS

Not Applicable.

### DETAILED DESCRIPTION OF A PREFERRED EMBODIMENT

Sheet molding compounds comprise a resinous “paste” and a fibrous “roving,” which are mixed and pressed between sheets of a removable film. An aspect of the present invention provides a low-density SMC-paste characterized in that they contain low amounts, if any of high-density fillers such as calcium carbonate. An aspect of the present invention is that the surface quality preserving function of calcium carbonate is served by a reduced level of high surface area fillers based on mixtures of nanoclays, diatomaceous earths, and kaolin clays.

An aspect of the invention provides an SMC-paste formulation comprising a thermosetting resin, an ethylenically unsaturated monomer, a low profiling additive, and an inventive nanoclay filler composition; wherein said SMC-paste has a density less than 1.25 g/cm³. According to an aspect, the inventive nanoclay composition is formulated separately and subsequently mixed with the resins, monomers, and the remaining components of the paste. According to a preferred aspect, the various components of the nanoclay composition and the SMC-paste are blended and the nanoclay forms in situ.

“Nanoclay” is defined as treated inorganic clay. Any treated inorganic clay can be used to practice this invention. The term “treated inorganic clay” is meant to include any layered clay having inorganic cations replaced with organic molecules, such as quaternary ammonium salts. See U.S. Pat. No. 5,853,886 for a description of various methods of preparing treated clay.

Nanoclays exfoliate in unsaturated polyester solutions and act as very efficient fillers. The degree of exfoliation of nanoclays controls their ability to contribute to the properties of resin-nanocomposite systems. Exfoliation relates to the delamination of the large stacks of silicate nanoplatelets into single layers, or into tactoids of a small number of layers. When delaminated, the enormous aspect ratio of the platelets contributes to the nanocomposite property profile. Nanoclays also control the rheology of the SMC formulation and improve wetting of the glass fiber reinforcement. Suitable nanoclays have been described in co-pending application Ser. No. 10/123,513, assigned to the assignee of the present invention, the entire contents of which is hereby incorporated for all purposes by reference. A suitable composition includes from about 0.1 to about 10 parts of nanoclay; preferably, from about 1 to about 4 parts and more preferably 1.5 to 3 parts per 100 parts (phr) of ‘formulated resin’. In low density SMC formulations, ‘formulated resin’ is defined as the sum of the thermosetting resin, low profile additive, reactive ethylenic monomers, and rubber impact modifier.

Typically, treated inorganic clays are prepared from layered inorganic clays such as phyllosilicates, e.g. montmorillonite, nontronite, beidellite, volkonskoite, hectorite, saponite, sauconite, magadiite, and kenyaite; vermiculite; and the like. Other representative examples include illite minerals such as ledikite; the layered double hydroxides or mixed metal hydroxides and chlorides. Other layered materials or multi-layer aggregates having little or no charge on the surface of the layers may also be used in this invention provided they can be intercalated to expand their interlayer spacing. Mixtures of one or more such materials may also be employed.

Preferred layered inorganic clays are those having charges on the layers and exchangeable ions such as sodium, potassium, and calcium cations, which can be exchanged, preferably by ion exchange, with ions, preferably cations such as ammonium cations, or reactive organosilane compounds, that cause the multi-lamellar or layered particles to delaminate or swell. The most preferred layered inorganic clay is montmorillonite.

The treated inorganic clay can be prepared by ion exchange in a separate step. This method first involves “swelling” clay with water or some other polar solvent, and then treating it with an intercalating agent. The function of the intercalating agent is to increase the “d-spacing” between the layers of the inorganic clay. The organophilic clay is then isolated and dried.

The treated clays can also be prepared in situ without ion exchange in separate step. The in situ treated clay is prepared by mixing layered inorganic clay with a monomer or resin that facilitates intercalation (intercalation-monomer), and an intercalating agent. In these treated clays, the cations replaced by the intercalating agent remain in the mixture.

Examples of intercalation-monomers that can be used to facilitate the intercalation agents include acrylic monomers, styrene, vinyl monomers (e.g. vinyl acetate), isocyanates (particularly organic polyisocyanates), polyamides, and polyamines. Examples of resins that can be used to facilitate intercalation include phenolic resins (e.g. phenolic resole resins; phenolic novolac resins; and phenolic resins derived from resorcinol, cresol, etc.); polyamide resins; epoxy resins, e.g. resins derived from bisphenol A, bisphenol F, or derivatives thereof, epoxy resins derived from the diglycidyl ether of bisphenol A or a polyol with epichlorohydrin; polyfunctional amines, e.g., polyalkylenepolyamine; and unsaturated polyester resins, e.g. reaction products of unsaturated dicarboxylic acids or their anhydrides and polyols. Examples of suitable unsaturated polyesters include the polycondensation products of (1) propylene glycol and maleic anhydride and/or fumaric acids; (2) 1,3-butanediol and maleic anhydride and/or fumaric acids; (3) combinations of ethylene and propylene glycols (approximately 50 mole percent or less of ethylene glycol) and maleic anhydride and/or fumaric acid; (4) propylene glycol, maleic anhydride and/or fumaric acid and saturated dibasic acids, such as o-phthalic, isophthalic, terephthalic, succinic, adipic, sebacic, methyl-succinic, and the like. Preferably, styrene is used to facilitate intercalation.

Although other intercalating agents can be used, preferably the intercalating agent is a quaternary ammonium salt. Typically, the quaternary ammonium salts (cationic surface active agents) have from 6 to 30 carbon atoms in the alkyl groups, e.g. alkyl groups such as octadecyl, hexadecyl, tetradecyl, dodecyl or like moieties; with preferred quaternary ammonium salts including octadecyl trimethyl ammonium salt, dioctadecyl dimethyl ammonium salt, hexadecyl trimethyl ammonium salt, dihexadecyl dimethyl ammonium salt, tetradecyl trimethyl ammonium salt, ditetradecyl dimethyl ammonium salt and the like. The amount of quaternary ammonium salt can vary over wide ranges, but is typically used in amount sufficient to replace from 30 to 100 percent of the cations of the inorganic clay with the cations of the intercalating agent. Typically, the amount of quaternary ammonium salt is from 10 to 60 parts by weight based on 100 parts by weight of inorganic clay, and preferably form 20 to 40 parts by weight based on 100 parts by weight of inorganic clay. The quaternary ammonium salt can be added directly to the inorganic clay, but is preferably first mixed with the monomer and/or resin used to facilitate intercalation.

An in situ treated clay is preferred because of its lower cost and it allows flexibility of design when preparing SMC, i.e. the intercalating agent can be selected to match the structure of the resin and have functional groups reactive with the resin. Additionally, the amount of intercalating agent can be varied in the range 5-50% per weight of the clay to obtain desired properties. A greater amount of intercalating agent provides more complete dispersion of the clays. This can yield significant improvements in the molding formulation, such as improved mechanical properties and increased transparency leading to moldings more easily pigmented. Increased dispersion, however, also yields a significant increase in viscosity, which can lead to poor glass wet-out in the SMC sheet. Therefore, it is necessary to balance the amount of clay and intercalating agent with the viscosity increase. The use of “treated inorganic clays” and low total filler loadings also yields SMC sheet that flows more easily when molded. Mold pressure can often be reduced to as little as one-third of that used for standard SMC. Molding at lower pressures dramatically reduces stress and wear on the press and the mold and often gives improved surface quality for the molded part.

The inventive low-density SMC-paste further comprises controlled proportions of kaolin clay. The clay has a particle size of from about 1 to about 5 microns. Preferably, the clay has a particle size of from about 3 to about 5 microns.

The inventive low-density, low profiling additive composition comprises controlled proportions of diatomacious earth. High surface area, shaped fillers such as diatomacious earth, mica, wollastonite, and kaolin clays maintain high strength at low levels, while helping to promote the efficient profiling of the LPA. SMC formulations using these fillers tend to be highly thixotropic, or shear thinning. They show excellent processing characteristics both on the SMC machine and in the mold.

The components of the nanocomposite composition, as numerically illustrated below, are given in parts per hundred parts (phr) of ‘formulated resin’ as defined above.

The inventive low-density, SMC-paste may further comprise a mineral filler such as, but not limited to mica and wollastonite. A suitable composition includes from about 1 to about 40 phr mineral filler, preferably, from about 5 to about 25 phr, and more preferably about 10-15 phr based on ‘formulated resin’.

The inventive low-density, SMC-paste may further comprise an organic filler such as, but not limited to graphite, ground carbon fiber, celluloses, and polymers. A suitable composition includes from about 1 to about 40 phr organic filler, preferably, from about 5 to about 30 phr and more preferably about 10-20 phr based on ‘formulated resin’.

The inventive low-density, SMC-paste further comprises a thermosetting resin. Although any thermosetting resin can be used in the SMC-paste, the resin preferably is selected from phenolic resins, unsaturated polyester resins, vinyl ester resins, polyurethane-forming resins, and epoxy resins.

Most preferably used as the thermosetting resin are unsaturated polyester resins. Unsaturated polyester resins are the polycondensation reaction product of one or more dihydric alcohols and one or more unsaturated, polycarboxylic acids. The term “unsaturated polycarboxylic acid” is meant to include unsaturated polycarboxylic and dicarboxylic acids; unsaturated polycarboxylic and dicarboxylic anhydrides; unsaturated polycarboxylic and dicarboxylic acid halides; and unsaturated polycarboxylic and dicarboxylic esters. Specific examples of unsaturated polycarboxylic acids include maleic anhydride, maleic acid, and fumaric acid. Mixtures of unsaturated polycarboxylic acids and saturated polycarboxylic acids may also be used. However, when such mixtures are used, the amount of unsaturated polycarboxylic acid typically exceeds fifty percent by weight of the mixture.

Examples of suitable unsaturated polyesters include the polycondensation products of (1) propylene glycol and maleic anhydride and/or fumaric acids; (2) 1,3-butanediol and maleic anhydride and/or fumaric acids; (3) combinations of ethylene and propylene glycols (approximately 50 mole percent or less of ethylene glycol) and maleic anhydride and/or fumaric acid; (4) propylene glycol, maleic anhydride and/or fumaric acid and saturated dibasic acids, such as o-phthalic, isophthalic, terephthalic, succinic, adipic, sebacic, methyl-succinic, and the like. In addition to the above-described polyester one may also use dicyclopentadiene modified unsaturated polyester resins as described in U.S. Pat. No. 3,883,612. These examples are intended to be illustrative of suitable polyesters and are not intended to be all-inclusive. The acid number to which the polymerizable unsaturated polyesters are condensed is not particularly critical with respect to the ability of the thermosetting resin to be cured to the desired product. Polyesters, which have been condensed to acid numbers of less than 100 are generally useful, but acid numbers less than 70, are preferred. The molecular weight of the polymerizable unsaturated polyester may vary over a considerable range, generally those polyesters useful in the practice of the present invention having a molecular weight ranging from 300 to 5,000, and more preferably, from about 500-4,000.

The inventive low-density, SMC-paste further comprises an unsaturated monomer that copolymerizes with the unsaturated polyester. The SMC formulation preferably contains an ethylenically unsaturated (vinyl) monomer. Examples of such monomers include acrylate, methacrylates, methyl methacrylate, 2-ethylhexyl acrylate, styrene, divinyl benzene and substituted styrenes, multi-functional acrylates and methacrylates such as ethylene glycol dimethacrylate or trimethylol propanetriacrylate. Styrene is the preferred ethylenically unsaturated monomer. The ethylenically unsaturated monomer is usually present in the range of about 20 to 50 phr, preferably from about 30 to about 45 phr, and more preferably from about 35 to about 45 phr based on ‘formulated resin’ defined as above. The vinyl monomer is incorporated into the composition generally as a reactive diluent for the unsaturated polyester. Styrene is the preferred intercalation monomer for forming the nanoclay composite in situ, and is also the preferred monomer for reaction with the resin.

The sheet molding compounds of the present invention may optionally comprise toughened, high elongation UPE resins. Such resins are used to modify the thermoset matrix where they help to improve and maintain toughness and mechanicals in low density SMC. It is critically important that those used have a neutral or positive impact on maintaining SQ.

The present invention further comprises a low profile additive (LPA) added to the formulation as an aid to reduce the shrinkage of molded articles prepared with the SMC. The LPA's used in the SMC typically are thermoplastic resins. Examples of suitable LPA's include saturated polyesters, polystyrene, urethane linked saturated polyesters, polyvinyl acetate, polyvinyl acetate copolymers, acid functional polyvinyl acetate copolymers, acrylate and methacrylate polymers and copolymers, homopolymers and copolymers include block copolymers having styrene, butadiene and saturated butadienes e.g. polystyrene. U.S. Pat. No. 5,116,917, assigned to the assignee of the present invention discloses low profile additive compositions comprising a non-gelling, saturated polyester formed from dibasic acid and an ethylene oxide/propylene oxide polyether polyol having an EO/PO molar ratio ranging from about 0.1 to 0.9. The polyester has an acid value of greater than about 10 and preferably has a number average molecular weight of greater than about 6,000. The EO/PO polyether polyol can be built on a combination of diol, triol or other compound with active hydrogen groups, so long as the LPA product does not gel.

The sheet molding compounds of the present invention may optionally comprise a low profile additive enhancer (LPA-enhancing additive) to aid in maintaining SQ and to improve the effectiveness, or “profiling efficiency” of thermoplastic LPA's as the density of the composite is reduced. Preferred LPA enhancers and methods for their preparation and use in SMC is disclosed by Fisher (U.S. Pat. No. 5,504,151) and Smith (U.S. Pat. No. 6,617,394 B2), assigned to the assignee of the present invention, the entire contents of which is specifically incorporated by reference for all purposes. The more preferred methodology is that disclosed by U.S. Pat. No. 5,504,151.

The sheet molding compounds of the present invention may optionally comprise rubber impact modifiers (a/k/a: “rubber tougheners”). It is well known to add rubber impact modifiers, as disclosed in U.S. Pat. No. 6,277,905, to reduce cracking in polyester thermoset composites by making the polymer matrix of the invention tougher. By “rubber impact modifiers”, impact modifiers that have rubbery physical properties are intended. These can include, for example, EP or EPDM rubbers which are grafted or copolymerized with suitable functional groups, such as: maleic anhydride, itaconic acid, acrylic acid, glycidyl acrylate, glycidyl methacrylate and mixtures thereof. Other examples of rubber impact modifiers include core/shell polymers having ‘shells’ of hard polymeric materials such as polystyrene, polyacrylonitrile, polyacrylate, and polymethacrylate mono-, co- or terpolymers, or styrene/acrylonitrile/glycidyl methacrylate terpolymers. Typically the soft, elastomeric cores are polymers and/or co- or terpolymers of butadiene, isoprene, alkyl acrylates, alkyl methacrylates, styrene, acrylonitrile, siloxanes, polyolefins, polyurethanes, polyesters, polyamides, polyethers, polysulfides and/or polyvinyl acetate, which are known to significantly reduce crack propagation in thermoset composite matrices. In practice, many of the elastomeric polymeric materials cited above can be effectively used without applying the shell material. Toughened, high elongation UPE resins are also used to modify the thermoset matrix where they help to improve and maintain toughness and mechanicals in low density SMC. Rubber impact modifiers also help in maintaining toughness and mechanical properties, such as tensile and flexural strength and modulus in low density SMC. It is also important that those used have a neutral or positive impact on maintaining SQ. The novel molding materials furthermore preferably contain from 0 to 10 parts, preferably, 3 to 6 parts of rubber impact modifiers based on each 100 parts of formulated resin in the composite compositions. ‘Formulated resin’ for these toughened systems is typically defined as the sum of the unsaturated polyester resin(s), reactive monomer(s), LPA(s), and rubber impact modifier(s).

Further suitable rubber impact modifiers are co- and terpolymers of alpha-olefins. The alpha-olefins are usually monomers of 2 to 8 carbon atoms, preferably ethylene and propylene. Alkyl acrylates or alkyl methacrylates derived from alcohols of 1 to 8 carbon atoms, preferably from ethanol, butanol or ethylhexanol, and reactive comonomers, such as acrylic acid, methacrylic acid, maleic acid, maleic anhydride or glycidyl (meth)acrylate, and furthermore vinyl esters, in particular vinyl acetate, have proven suitable comonomers. Mixtures of different comonomers may also be used. Copolymers of ethylene with ethyl or butyl acrylate and acrylic acid and/or maleic anhydride have proven particularly suitable. Copolymers of ethylene, methyl acrylate and glycidyl methacrylate are preferred. Also, copolymers of ethylene plus methyl acrylate are preferred, as are two or more copolymer types present in the invention as a mixture.

A further group of suitable impact modifiers comprises core-shell graft rubbers. These are graft rubbers prepared in emulsion and consisting of at least one hard and one soft component. A hard component is usually understood as meaning a polymer having a glass transition temperature of at least 25° C., and a soft component as meaning a polymer having a glass transition temperature of not more than 0° C. These products have a structure having a core and at least one shell, the structure being determined by the order of addition of the monomers. The soft components are generally derived from butadiene, isoprene, alkyl acrylates, alkyl methacrylates or siloxanes and, if required, further comonomers. Suitable siloxane polymers can be prepared, for example, starting from cyclic octamethyltetrasiloxane or tetravinyltetramethyltetrasiloxane. These polymers can be prepared by ring-opening cationic polymerization, for example using γ-mercaptopropylmethyldimethoxysilane, preferably in the presence of sulfonic acids. The siloxanes may also be cross-linked by, for example, carrying out the polymerization reaction in the presence of silanes having hydrolyzable groups, such as halogen or alkoxy, e.g. tetraethoxysilane, methyltrimethoxysi lane or phenyltrimethoxysi lane. Examples of suitable comonomers include styrene, acrylonitrile and cross-linking or graft-active monomers having more than one polymerizable double bond, such as diallyl phthalate, divinylbenzene, and butanediol diacrylate or triallyl (iso) cyanurate. The hard components are derived, in general, from styrene, α-methylstyrene and copolymers thereof, acrylonitrile, methacrylonitrile and methylmethacrylate preferably being used as comonomers.

Preferred core-shell graft rubbers contain a soft core and a hard shell or a hard core, a first soft shell and at least one further hard shell. Functional groups, such as carbonyl, carboxyl, anhydride, amido, imido, carboxylic ester, amino, hydroxyl, epoxy, oxazoline, urethane, urea, lactam or halobenzyl groups, are preferably incorporated here by adding suitable functionalized monomers in monomers. The soft components are generally derived from butadiene, isoprene, alkyl acrylates, alkyl methacrylates or siloxanes and, if required, further comonomers. Suitable siloxane polymers can be prepared, for example, starting from cyclic octamethyltetrasiloxane or tetravinyltetramethyltetrasiloxane. These polymers can be prepared by ring-opening cationic polymerization, for example using gamma-mercaptopropylmethyldimethoxysilane, preferably in the presence of sulfonic acids. The siloxanes may also be cross-linked by, for example, carrying out the polymerization reaction in the presence of silanes having hydrolyzable groups, such as halogen or alkoxy, e.g. tetraethoxysilane, methyltrimethoxysilane or phenyltrimethoxysilane. Examples of suitable comonomers here are styrene, acrylonitrile and crosslinking or graft-active monomers having more than one polymerizable double bond, such as diallyl phthalate, divinylbenzene, butanediol diacrylate or triallyl (iso)cyanurate. The hard components are derived in general from styrene, alpha-methylstyrene and copolymers thereof, acrylonitrile, methacrylonitrile and methylmethacrylate preferably being used as comonomers. Preferred core-shell graft rubbers contain a soft core and a hard shell or a hard core, a first soft shell and at least one further hard shell. Functional groups, such as carbonyl, carboxyl, anhydride, amido, imido, carboxylic ester, amino, hydroxyl, epoxy, oxazoline, urethane, urea, lactam or halobenzyl groups, are preferably incorporated here by adding suitable functionalized monomers in the polymerization of the final shell. Suitable functionalized monomers are, for example, maleic acid, maleic anhydride, mono- or diesters of maleic acid, tert-butyl (meth)acrylate, acrylic acid, glycidyl (meth)acrylate and vinyloxazoline. The amount of monomers having functional groups is in general from 0.1 to 25, preferably from 0.25 to 15%, by weight, based on the total weight of the core-shell graft rubber. The weight ratio of soft to hard components is in general from 1:9 to 9:1, preferably from 3:7 to 8:2. Such rubbers are known per se and are described, for example, in EP-A 208 187. In practice, many of the elastomeric polymeric materials cited above can be effectively used without applying the shell material. It is also important that any polymeric materials so used have a neutral or positive impact on the SQ of the molded part.

The inventive SMC-paste optionally contains a SQ-maintaining monomer, which may be termed an alternative reactive monomer (ARM). Alternative reactive monomers have shown the ability to aid in maintaining SQ as the density of the composite is reduced. A preferred ARM is divinylbenzene. Surprisingly, replacing a minor portion of the system's styrene with DVB not only aids in maintaining SQ but also substantially reduces the viscosity of the SMC Paste. SQ-maintaining monomers are disclosed in co-pending docket (number not yet assigned; Attorney Docket Number 20435-00168) the entire contents of which is hereby incorporated in its entirety.

The SMC preferably contains a low-density filler. A low-density filler is one having a density of 0.5 g/cm³ to 2.0 g/cm³, preferably from 0.7 g/cm³ to 1.3 g/cm³. Examples of low-density fillers include diatomaceous earth, hollow microspheres, ceramic spheres, and expanded perlite, and vermiculate. One must, however, be judicious in the selection of the low-density filler(s) used. Most types of ‘hollow microspheres’ render the surface of the molded SMC part ‘unsandable’ if the repair of ‘paint pop defects’ is required. Sanding during such repairs will typically break open the ‘hollow microspheres’ near the surface, introducing new porosity, which yields additional ‘paint pop defects’ when the part is repainted. To eliminate such potential defect sites; ‘hollow microspheres’ are not a preferred low-density filler for use in the invention.

Although not necessarily preferred, particularly in major amounts, higher-density fillers, such as calcium carbonate, talc, kaolin, carbon, silica, and alumina may be also added to the SMC. Higher-density fillers may be incorporated so long as the density of the molded SMC part does not exceed 1.6 g/cm³.

The paste compositions of the present invention comprise: (a) from about 30 to 70 phr of thermosetting resin as styrene solution, preferably from about 45 to 65 phr; (b) from about 1 to 10 phr of treated inorganic clay, preferably from about 1 to 6 phr and more preferably from 1 to 3 phr; (c) from about 10 to 40 phr of low profile additive, typically as a 50% solution in styrene, preferably from about 14 to 32 phr; (d) from 0 to 10 phr additional styrene, preferably from 0 to 5 phr; (e) from 0 to 65 phr of an inorganic filler, preferably from about 30 to 55 phr; and (f), from 1 to 10 phr of an alternate reactive monomer (ARM), preferably from 2 to 6 parts phr based on 100 parts of ‘formulated resin’ as defined above. The preferred ARM is a multi-ethylenic aromatic monomer, with the most preferred ARM being divinylbenzene. The SMC sheet comprises from 60 to 85 weight percent SMC paste, with fiber reinforcement as the remaining 15 to 40 weight percent, or more preferably, about 25 to 35 weight percent of the molding compound.

The SMC also preferably contains an organic initiator. The organic initiators are preferably selected from organic peroxides which are highly reactive and decomposable at the desired temperature and having the desired rate of curing. Preferably, the organic peroxide is selected from those, which are decomposable at temperatures from about 50° C. to about 120° C. The organic peroxides to be used in the practice of the invention are typically selected from tertiary butyl peroxy 2-ethylhexanoate; 2,5-dimethyl-2,5-di(-benzoylperoxy)cyclohexane; tertiary-amyl 2-ethylhexanoate and tertiary-butyl isopropyl carbonate; tertiary-hexylperoxy 2-ethylhexanoate; 1,1,3,3-tetramethylbutylperoxy 2-ethylhexanoate; tertiary-hexylperoxypivalate; tertiarybutylperoxy pivalate; 2,5-dimethyl-2,5-di(2-ethylhexanoylperoxy) cyclohexane; dilauroyl peroxide; dibenzoyl peroxide; diisobutyryl peroxide; dialkyl peroxydicarbonates such as diisopropyl peroxydicarbonate, di-n-propyl peroxydicarbonate, di-sec-butyl peroxydicarbonate, dicyclohhexyl peroxydicarbonate; VAZ052, which is 2,2′-azobis(2,4-dimethyl-valeronitrile); di-4-tertiarybutylcyclohexyl peroxydicarbonate and di-2 ethylhexyl peroxydicarbonate and t-butylperoxy esters, such as tertiary butylperpivalate and teriarybutylper pivalate and eodecanoate. More preferably, the initiator is a blend of t-butylperoxy-2-ethylhexanoate and t-butylperoxybenzoate. The initiators are used in a proportion that totals from about 0.1 parts to about 6 phr, preferably from about 0.1 to about 4, and more preferably from about 0.1 to about 2 phr, based on 100 parts of the ‘formulated resin’ as defined above.

The SMC paste may also contain a stabilizer or inhibitor. The stabilizers preferably are those having high polymerization inhibiting effect at or near room temperature. Examples of suitable stabilizers include hydroquinone; toluhydroquinone; di-tertiarybutylhydroxytoluene (BHT); para-tertiarybutylcatechol (TBC); mono-tertiarybutylhydroquinone (MTBHQ); hydroquinone monomethyl ether; butylated hydroxyanisole (BHA); hydroquinone; and parabenzoquinone (PBQ). The stabilizers are used in a total amount ranging from about 0.01 to about 0.4 phr, preferably from about 0.01 to about 0.3 phr and more preferably from about 0.01 to about 0.2 phr of the ‘formulated resin’ as defined above.

The composition of the sheet molding paste may further include a thickening agent such as oxides, hydroxides, and alcoholates of magnesium, calcium, aluminum, and the like. The thickening agent can be incorporated in a proportion ranging from about 0.05 phr to about 5 parts phr, preferably from about 0.1 phr to about 4 phr and, more preferably, from about 1 phr to about 3 phr based on the ‘formulated resin’ as defined above. Additionally or alternatively, the SMC may contain isocyanate compounds and polyols or other isocyanate reactive compounds, which may be used to thicken the SMC.

The SMC paste may also contain other additives, e.g. cobalt promoters (Co), nucleating agents, lubricants, plasticizers, chain extenders, colorants, mold release agents, antistatic agents, pigments, fire retardants, and the like. The optional additives and the amounts used depend upon the application and the properties required.

Sheet molding compounds (SMC) fabricated from the SMC-paste of the present invention, contain a reinforcing agent, preferably a fibrous reinforcing agent, termed roving. Fibrous reinforcing agents are added to the SMC to impart strength and other desirable physical properties to the molded articles formed from the SMC. Examples of fibrous reinforcements that can be used in the SMC include glass fibers, carbon fibers, polyester fibers, and natural organic fibers such as cotton and sisal. Particularly useful fibrous reinforcements include glass fibers which are available in a variety of forms including, for example, mats of chopped or continuous strands of glass, glass fabrics, chopped glass and chopped glass strands and blends thereof. Preferred fibrous reinforcing materials include 0.5, 1, and 2-inch fiberglass fibers.

The SMC are useful for preparing molded articles, particularly sheets and panels. The sheets and panels may be shaped by conventional processes such as vacuum processing or by hot pressing. The SMC are cured by heating, contact with ultraviolet radiation, and/or catalyst, or other appropriate means. The sheets and panels can be used to cover other materials, for example, wood, glass, ceramic, metal, or plastics. They can also be laminated with other plastic films or other protective films. They are particularly useful for preparing parts for recreational vehicles, automobiles, boats, and construction panels.

### EXAMPLE

EXAMPLE
TLM Class A SMC

| Components | |
|---|---|
| Q6585 | 43.85 |
| Tough UPE Resin | 14.01 |
| Q8000 | 28.00 |
| TS 7100 | 4.00 |
| 12% CoNaphthanate | 0.05 |
| Divinylbenzene | 6.00 |
| Styrene | 4.10 |
| Resin Mix | 100.00 |
| Mod E | 0.60 |
| PDO | 0.27 |
| TBPB | 1.50 |
| ASP400P | 35.00 |
| Diatomaceous Earth | 10.00 |
| Wallastonite | 10.00 |
| Cloisite Na+ | 2.00 |
| BTC8249 | 0.56 |
| B-Side: Aropol 59040 | 3.00 |
| Total | 173.58 |
| Shrinkage (paste panel-mil/in) | 0.2 |
| Glass Drop: | 128 g |
| Gap: | 0.055 in. |
| Temperature (° C.) | 35° C. |
| Mixed Paste Viscosity (cPs) | 25000 |
| Molding Viscosity (MM cps) | 35 |
| Ashland Index SQ by LORIA | 70 |
| DOI | 80 |
| Orange Peel | 7.6 |
| Tensile Strength/Mod. (ksi) | 11.5/1200 |
| Flexural Strength/Mod. (ksi) | 26.5/1350 |
| Composite Density | 1.58 |
| Molding Temperature | 300° F. |

Surface quality (SQ), as measured by the Laser Optical Reflected Image Analyzer, or LORIA, is determined by three measurements—Ashland Index (AI), Distinctness of Image (DOI), and Orange Peel (OP). SMC with Class A SQ is typically defined as having an AI<80, a DOI≧70 (scale 0-100), and an OP≧7.0 (scale 0-10). A preferred methodology for the determination of surface quality is disclosed by Hupp (U.S. Pat. No. 4,853,777), the entire content of which is specifically incorporated by reference for all purposes.

In addition to SQ, the mechanical properties of the inventive SMC were determined. The tensile strength is measured by pulling a sample in an Instron instrument as is conventional in the art. The tensile modulus is determined as the slope of the stress-strain curve generated by measurement of the tensile strength. Flexural strength is determined conventionally using an Instron instrument. The flexural modulus is the slope of the stress-strain curve. Toughness is conventionally the area under the stress-strain curve.

A conventional “tough” SMC formulation has the following approximate composition (based on 100 g of formulated resin): 48.7 g of a high reactivity unsaturated polyester (UPE) in styrene solution; 16.3 g of a “tough” reactive UPE in styrene solution; 7 g of a styrene monomer; and 28 g of low profile additives (LPA) as a 50% styrene solution. For each ‘100 g of ‘formulated resin’, 190 g of calcium carbonate filler; 9 g of magnesium oxide containing thickener; 4.5 g zinc stearate mold release; 1.5 g tertiary butyl perbenzoate catalyst; and 0.05 g of a co-activator (cobalt, 12% in solution) are charged to generate the ‘SMC paste.’ Conventional SMC formulations typically have densities of >1.9 g/cc for molded parts. The present invention provides molded parts having a density of from 1.45 to 1.6 g/cc while maintaining the mechanicals, Class A SQ, and toughness. As the density is reduced, however, maintaining these properties becomes increasingly difficult. The present invention provides a tough, low-density SMC having industry-required mechanicals and Class A SQ by replacing high-density calcium carbonate with an inventive additive package of high surface area fillers that promote efficient low profiling.

The filler package for low density SMC might include 1-6 g of nanoclay, 0-20 g of diatomaceous earth, 0 to 25 g mica, 0 to 25 g wollastonite, 0 to 25 g of ground carbon fiber and/or 0 to 60 g kaolin clay, CaCO3, graphite or aluminum trihydrate per 100 g of the ‘formulated resin’ as defined above. Combinations of these fillers totaling 35 to 65 g are typically required to maintain the desired properties as the density is lowered. However, the high surface area and irregular shape of these fillers also give them a very high resin demand. Even with the use of commercial viscosity reducing additives, the optimal level for an individual filler type will be limited by its impact on the resin paste viscosity. The resin paste viscosity is typically kept between 15,000 and 35,000 cps to control paste ‘sag’ and ensure proper ‘wet-out’ of the glass reinforcement during preparation of the SMC.

The invention is illustrated with one example. SMC paste formulations were evaluated for shrinkage and molded into cured reinforced panels. To evaluate shrinkage, SMC paste without fiber glass was molded and cured in a Carver Laboratory Press at 300° F. and evaluated for shrinkage. For further testing, SMC paste was combined, on a SMC machine, with fiber glass roving, chopped to 1-inch lengths, allowed to thicken for 2 to 3 days, and then molded at 300° F. to form 0.1 inch thick plates. The plates were tested for density, surface appearance, and mechanical strength. The surface appearance was analyzed using a LORIA surface analyzer to measure AI for ‘long term waviness’ and DOI and OP for ‘short term’ surface distortion.

The data in Table I shows the formulations containing nanoclay and lowered filler levels required to yield low density, 1.5-1.6 g/cc, SMC moldings. Note the excellent overall SQ of the control (˜1.9 g/cc). The data for formulations TLM-1 through TLM-12 clearly show that obtaining a lower density SMC with acceptable overall SQ is not simply a matter of reducing the CaCO₃ level. In fact, they show that a blend of specific fillers, having differing shapes and surface area, show a unique synergism that improves shrinkage control of the filled matrix during cure. This reduction in shrinkage allows one to achieve class A SQ for reinforced composite panels. The data also shows that the correct blend of fillers is key. Note that TLM-5 and TLM-7, which contain CaCO₃, show significantly more shrinkage and reduced SQ compared to TLM-6 and TLM-8 where clay is the third filler component.

It should be noted that cure shrinkage of the filled resin can be significantly reduced when higher levels of wollastonite, mica, and diatomaceous earth are used. However, using higher levels of these fillers cause a large increase in the viscosity of the resin paste and gives poor glass ‘wet-out’ when preparing SMC. Poor sheet ‘wet-out’ causes a multitude of problems when the SMC is molded, including poor SQ, reduced physical properties, delamination, and ‘blistering’. In addition, we have found that using only modest levels of “reinforcing fillers,” such as wollastonite and mica, are of significant help in maintaining mechanical properties, especially the tensile and flexural moduli, as overall filler levels are reduced.

This invention shows the advantage of incorporating a unique blend of fillers into the additive package. These fillers promote efficient profiling by the LPA and aid in maintaining mechanical properties and matrix toughness without increasing the paste viscosity above the range of 15,000 to 35,000 centipoise that is typically desired for SMC sheet preparation. These fillers may include commercial or in-situ prepared nanoclays, kaolin, diatomacious earth, mica, wollastonite, graphite, ground carbon fiber, cellulose-based fillers, and the like.

Further aspects of the present invention relate to methods and processes for fabricating molded composite vehicle and construction parts having a density less than 1.6 grams per cm³. In an aspect the methods comprises admixing unsaturated polyester thermosetting resin, an olefinically unsaturated monomer capable of copolymerizing with the unsaturated polyester resin, a thermoplastic low profile additive, free radical initiator, alkaline earth oxide or hydroxide thickening agent, and a nanoclay composite filler composition. According to an aspect, the nanoclay composite is provided as a pre-formed composition. According to another aspect, the nanoclay composite is formed in situ from precursor materials.

According to an aspect of the method, the various starting materials are mixed to form a paste which is dispensed on a carrier film above and below a bed of chopped roving, forming a molding sheet. According to an aspect, the molding sheet is enveloped in a carrier film and consolidated. According to further aspects of the method, the sheet is matured until a molding viscosity of 3 million to 70 million centipoise is attained and the sheet is non-tacky. Following consolidation, the sheet is released from the carrier film.

According to various aspects of the inventive method, the consolidated sheet is molded into composite parts to be assembled into vehicles. The sheets may be molded into composite construction materials. According to an aspect of the method, the sheets are placed in a heated mold and compressed under pressure whereby a uniform flow of resin, filler and glass occurs outward to the edges of said part. Table 2 demonstrates the performance of the inventive SMC at various molding temperatures. According to an aspect, the sheet is heated in the mold to a temperature from 250° F. to 305° F. In a preferred aspect the sheet is heated to a temperature of from 270° F. to 290° F. In a most preferred aspect the sheet is heated to a temperature of from 275° F. to 285° F. Table 3 demonstrates the performance of the inventive SMC at various molding pressures. In an aspect, the sheets are molded at a pressure of from 200 psi to 1400 psi; preferably from 400 psi to 800 psi.

According to preferred aspects, the paste is composed of auxiliary components that may include mineral fillers, organic fillers, auxiliary monomers, rubber impact modifiers, resin tougheners, organic initiators, stabilizers, inhibitor, thickeners, cobalt promoters, nucleating agents, lubricants, plasticizers, chain extenders, colorants, mold release agents, antistatic agents, pigments, fire retardants, and mixtures thereof.

The foregoing description of the invention illustrates and describes the present invention. Additionally, the disclosure shows and describes only the preferred embodiments of the invention but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

### INCORPORATION BY REFERENCE

All publications, patents, and pre-grant patent application publications cited in this specification are herein incorporated by reference, in their respective entireties and for any and all purposes, as if each individual publication or patent application were specifically and individually indicated to be incorporated by reference. Specifically co-pending applications (numbers not yet assigned, Attorney Docket Numbers 20435-00168 and 20435-00169) and co-pending application Ser. No. 10/123,513 are hereby incorporated in their respective entireties for all purposes. In the case of inconsistencies the present disclosure will prevail.

Having thus described our invention, what we claim as new, and desire to secure by Letters Patent is:

1. A sheet molding compound paste (SMC-paste) formulation comprising:
a thermosetting resin,
an ethylenically unsaturated monomer;
a low profiling additive; and
a nanoclay filler composition, wherein said SMC-paste has a density less than 1.25 g/cm³.

2. The SMC-paste formulation, according to claim 1, wherein said nanoclay filler composition comprises:
a layered inorganic clay;
an organic intercalating agent;
diatomaceous earth; and
kaolin clay.

3. The SMC-paste formulation, according to claim 2, wherein said layered inorganic clay comprises a clay selected from the group consisting of phyllosilicates, vermiculites, illite minerals, layered double hydroxides, mixed metal hydroxides and chlorides, and mixtures thereof.

4. The SMC-paste formulation, according to claim 2, wherein said organic intercalating agent comprises an agent selected from the group consisting of quaternary ammonium salts, organometallics, tertiary amines, grafted polymers, and mixtures thereof.

5. The SMC-paste formulation, according to claim 4, wherein a preferred organic intercalating agent comprises a quaternary ammonium salt.

6. The SMC-paste formulation, according to claim 2, wherein said nanoclay filler composition further comprises an intercalation-facilitating agent selected from the group consisting of monomers, resins, and mixtures thereof.

7. The SMC-paste formulation, according to claim 6, wherein said intercalation-facilitating agent is styrene.

8. The SMC-paste formulation, according to claim 2, wherein said kaolin clay has a particle size of from about 1 to about 5 microns.

9. The SMC-paste formulation, according to claim 1, further comprising a reinforcing mineral filler.

10. The SMC-paste formulation, according to claim 9, wherein said mineral filler is selected from the group consisting of mica, wollastonite, and mixtures thereof.

11. The SMC-paste formulation, according to claim 1, further comprising an organic filler selected from the group consisting of graphite, ground carbon fiber, celluloses, polymers, and mixtures thereof.

12. The SMC-paste formulation, according to claim 1, wherein said thermosetting resin is a toughened, high-elongation unsaturated polyester resin.

13. The SMC-paste formulation, according to claim 1, wherein said toughened, high-elongation UPE comprises a [polyethylene] glycol maleate UPE modified with at least one substituent selected from the group consisting of aromatic dibasic acids, aliphatic dibasic acids, glycols[, polyglycols] having from 2 to 8 carbons, and mixtures thereof.

14. The SMC-paste formulation, according to claim 1, wherein said ethylenically unsaturated monomer is selected from the group consisting of acrylate, methacrylates, methyl methacrylate, 2-ethylhexyl acrylate, styrene, divinyl benzene and substituted styrenes, multi-functional acrylates, ethylene glycol dimethacrylate, trimethylol propanetriacrylate, and mixtures thereof.

15. The SMC-paste formulation, according to claim 14, wherein a preferred ethylenically unsaturated monomer is styrene.

16. The SMC-paste formulation, according to claim 1, wherein said low profiling additive is a thermoplastic resin.

17. The SMC-paste formulation, according to claim 16, wherein said low profiling thermoplastic resin is selected from the group consisting of saturated polyester, polyurethane, polyvinyl acetate, polymethylmethacrylate, polystyrene, epoxy-extended polyester, and mixtures thereof.

18. The SMC-paste formulation, according to claim 1, further comprising a LPA-enhancer.

19. The SMC-paste formulation, according to claim 1, further comprising a rubber impact modifier.

20. The SMC-paste formulation, according to claim 19, wherein said rubber impact modifier comprises an elastomeric material.

21. The SMC-paste formulation, according to claim 1, further comprising an additive selected from the group consisting of organic initiators, stabilizers, inhibitor, thickeners, cobalt promoters, nucleating agents, lubricants, plasticizers, chain extenders, colorants, mold release agents, antistatic agents, pigments, fire retardants, and mixtures thereof.

22. A low-density sheet molding compound (SMC) comprising:
a fibrous roving material; and the SMC-paste of claim 1, wherein said SMC sheet has a density less than about 1.6 g/cm³.

23. An article of manufacture comprising the low-density SMC of claim 23.

24. The article of manufacture, according to claim 24, wherein said article has a Class A Surface Quality.

25. A method of fabricating an article of manufacture comprising heating under pressure the low-density SMC of claim 23.

26. A method of fabricating a low-density SMC comprising:
providing a formulated nanoclay composite;
providing an unsaturated polyester resin;
providing an olefinically unsaturated monomer capable of copolymerizing with said unsaturated polyester resin; and
curing said mixture, with the proviso that the density of said cured SMC molding be less than about 1.6 g/cm³.

27. The method of fabricating a low-density SMC, according to claim 27, further comprising:
providing a low-profiling additive; and
providing a low-profiling additive enhancer.

28. The method of fabricating a low-density SMC, according to claim 27, further comprising providing auxiliary components selected from the group consisting of mineral fillers, organic fillers, auxiliary monomers, rubber impact modifiers, resin tougheners, organic initiators, stabilizers, inhibitor, thickeners, cobalt promoters, nucleating agents, lubricants, plasticizers, chain extenders, colorants, mold release agents, antistatic agents, pigments, fire retardants, and mixtures thereof.

29. A method of fabricating a low-density SMC comprising forming a nanoclay composite in situ within an uncured resin—monomer mixture and curing said mixture, wherein said SMC molding has a density less than about 1.6 g/cm³.

30. The method of fabricating a low-density SMC, according to claim 30, comprising:
providing a layered inorganic clay,
providing an intercalation agent,
providing an intercalation monomer,
providing an unsaturated polyester resin,
providing an olefinically unsaturated monomer capable of copolymerizing with the unsaturated polyester resin, and
curing said mixture.

31. The method of fabricating a low-density SMC, according to claim 31, further comprising:
providing low-profiling additive; and
providing an enhancer for a low-profiling additive.

32. The method of fabricating a low-density SMC, according to claim 31, further comprising providing auxiliary components selected from the group consisting of mineral fillers, organic fillers, auxiliary monomers, rubber impact modifiers, resin tougheners, organic initiators, stabilizers, inhibitor, thickeners, cobalt promoters, nucleating agents, lubricants, plasticizers, chain extenders, colorants, mold release agents, antistatic agents, pigments, fire retardants, and mixtures thereof.

33. A process for making molded composite vehicle and construction parts having a density less than 1.6 grams per cm³, comprising:
admixing unsaturated polyester thermosetting resin, an olefinically unsaturated monomer capable of copolymerizing with the unsaturated polyester resin, a thermoplastic low profile additive, free radical initiator, alkaline earth oxide or hydroxide thickening agent, and a nanoclay composite filler composition;
forming a paste;
dispensing said paste on a carrier film above and below a bed of roving, forming a molding sheet;
enveloping said sheet in the carrier film;
consolidating said sheet;
maturing said sheet until a matured molding viscosity of 3 million to 70 million centipoise is attained and said sheet is non-tacky, releasing said sheet from said carrier film;
compression molding said sheet into a part in a heated mold under pressure whereby a uniform flow of resin, filler and glass occurs outward to the edges of said part; and
removing said molded part.

34. The process of claim 33 wherein said molding pressure for the part is from 200 psi to 1400 psi; preferably from 400 psi to 800 psi.

35. The process of claim 33 wherein said molding temperature for the part is from 250° F. to 315° F.; preferably from 270° F. to 290° F.; and most preferably from 275° F. to 285° F.

36. The process of claim 33 wherein said molded part has a surface smoothness quality less than a 100 Ashland LORIA analyzer index.

37. The method of fabricating a low-density SMC, according to claim 33, further comprising providing auxiliary components selected from the group consisting of LPA-enhancers, mineral fillers, organic fillers, auxiliary monomers, rubber impact modifiers, resin tougheners, organic initiators, stabilizers, inhibitor, thickeners, cobalt promoters, nucleating agents, lubricants, plasticizers, chain extenders, colorants, mold release agents, antistatic agents, pigments, fire retardants, and mixtures thereof.
